(19) United States
(12) Patent Application Publication
(10) Pub. No.: US 2016/0145487 A1
(43) Pub. Date: May 26, 2016

(54) ASPHALTENE-DISSOLVING OIL-EXTERNAL EMULSION FOR ACIDIZATION AND METHODS OF USING THE SAME

(71) Applicant: HALLIBURTON ENERGY SERVICES, INC., Houston, TX (US)

(72) Inventors: MD Monsur Alam, Houston, TX (US); Humberto Almeida Oliveira, The Woodlands, TX (US); Weiming Li, Katy, TX (US); Jason Eric Maxey, Spring, TX (US)

(21) Appl. No.: 14/898,336

(22) PCT Filed: Sep. 11, 2013
(86) PCT No.: PCT/US13/59255

§ 371 Date: Dec. 14, 2015

(51) Int. Cl. C09K 8/74; E21B 43/16; C09K 8/524

(52) U.S. Cl. CPC C09K 8/74; C09K 8/524; E21B 43/16

(57) ABSTRACT

The present invention relates to an asphaltene-dissolving oil-external emulsion for acidization and methods of using the same. In various embodiments, the present invention provides a method of treating a subterranean formation, including obtaining or providing an oil-external water-internal emulsion. The emulsion includes an asphaltene-dissolving composition, emulsifier, and aqueous acid. The method also includes placing the composition in a subterranean formation downhole.

### BACKGROUND OF THE INVENTION

Asphaltenes are black, carbonaceous components of petroleum which occur in many crude oils in solution or as colloidal, suspended, solid particles. Under static reservoir conditions, asphaltenes normally stay in solution or are held in a static suspension. Changes in fluid temperature and pressure associated with oil production, or additions of various solvents to the reservoir fluid, can cause the asphaltenes to flocculate and precipitate out of suspension and deposit on or adsorb to the formation or pipe surfaces. Asphaltenes can cause serious production problems, such as decreasing permeability of the formation and increasing the possibility of expensive mechanical failure.

Acidization treatments include pumping acid into the well to increase permeability. Acidization can be performed below the reservoir fracture pressure (matrix acidizing) or above the reservoir fracture pressure (fracture acidizing). Asphaltenes can interfere with the effectiveness of acid to dissolve acid-soluble rock in the formation and can hinder permeability. Asphaltene-dissolving solvents can be used as a pre-acidization wash, requiring a time consuming separate step. Acidization compositions including diesel can destabilize the reservoir fluid, such as sludging and asphaltenic oils, causing increased precipitation and deposition of asphaltenes.

### SUMMARY OF THE INVENTION

In various embodiments, the present invention provides a method of treating a subterranean formation. The method includes obtaining or providing a composition including an oil-external water-internal emulsion. The emulsion includes an asphaltene-dissolving composition. The emulsion includes an emulsifier. The emulsion also includes an aqueous acid. The method also includes placing the composition in a subterranean formation downhole.

In various embodiments, the present invention provides a method of treating a subterranean formation. The method includes obtaining or providing a composition including an oil-external water-internal emulsion. The emulsion includes an external phase that is about 10% to about 50% of the emulsion by volume. The external phase includes an asphaltene-dissolving composition. The asphaltene-dissolving composition includes heavy aromatic petroleum naptha. The asphaltene-dissolving composition also includes a polar organic compound miscible with the heavy aromatic petroleum naptha. The emulsion includes an internal phase that is about 50% to about 90% of the emulsion by volume. The internal phase includes aqueous acid. The emulsion also includes an emulsifier. The emulsifier includes a polyaminated fatty acid. The method includes placing the composition in a subterranean formation.

In various embodiments, the present invention provides a system. The system includes a composition including an oil-external water-internal emulsion. The emulsion includes an asphaltene-dissolving composition, emulsifier, and aqueous acid. The system also includes a subterranean formation including the composition therein.

In various embodiments, the present invention provides a composition for treatment of a subterranean formation. The composition includes an oil-external water-internal emulsion. The emulsion includes an asphaltene-dissolving composition, emulsifier, and aqueous acid.

In various embodiments, the present invention provides a composition for treatment of a subterranean formation. The composition includes an oil-external water-internal emulsion. The emulsion includes an external phase that is about 10% to about 50% of the emulsion by volume. The external phase includes an asphaltene-dissolving composition. The asphaltene-dissolving composition includes heavy aromatic petroleum naptha. The asphaltene-dissolving composition also includes a polar organic compound miscible with the heavy aromatic petroleum naptha. The emulsion includes an internal phase that is about 50% to about 90% of the emulsion by volume. The internal phase includes aqueous acid. The emulsion also includes an emulsifier. The emulsifier includes a polyaminated fatty acid.

In various embodiments, the present invention provides a method of preparing a composition for treatment of a subterranean formation. The method includes forming an oil-external water-internal emulsion. The emulsion includes an asphaltene-dissolving composition, emulsifier, and aqueous acid.

Various embodiments of the present invention provide certain advantages over other compositions and methods for acidization, at least some of which are unexpected. For example, in some embodiments, the method can eliminate the dual stages of acidization and asphaltene removal by combining the stimulation and cleaning stages into a single treatment, decreasing operation time, mixing time, and handling of multiple fluids. In some embodiments, the oil-external emulsion and method of using the same can have a cost similar, equal to, or less than the cost of dual stage asphaltenes removal and acidization treatments. In some embodiments, the oil-external emulsion can destabilize reservoir fluids less than other acidization treatments, thereby causing less precipitation and deposition of asphaltenes during the stimulation treatment. In some embodiments, the oil-external emulsion can leave substantially no residue in the formation after the acidization treatment, thereby reducing the need for backflushing operations. In some embodiments, the oil-external emulsion can have a higher flash point than other asphaltene removers or acidization treatments, such as acidization treatments including other solvents such as xylenes, making the oil-external emulsion a safer alternative. In some embodiments, at least one of the composition and the oil-external emulsion can be substantially free of benzene, toluene, ethylbenzene, and xylenes, and can be more environmentally-friendly.

In some embodiments, the oil-external emulsion can give more effective wormholing, which results in higher permeability. In some embodiments, the oil-external emulsion can easily be configured to have a desired viscosity suitable for use in a particular application. In some embodiments, the oil-external emulsion can give better leak-off control than other stimulation and acidization methods and compositions. In some embodiments, the oil-external emulsion can be a superior and more robust emulsion as compared to other acidization emulsions, with greater stability under a variety of shear conditions. In some embodiments, the high stability of the oil-external emulsion permits it to be pumped through smaller bore tubing than is possible with other acidization compositions, such as coiled tubing.

In various embodiments, the oil-external emulsion can be free of diesel. In some embodiments, the substantial lack of diesel in the oil-external emulsion can allow the emulsion to cause less destabilization of reservoir fluid during the stimulation treatment, thereby causing less precipitation and deposition of asphaltenes. Due to surface limitations and handling issues, production platforms sometimes do not accept diesel flowback; in some embodiments, the substantial lack of diesel in the oil-external emulsion can result in no diesel flowback. In various embodiments, the oil-external emulsion can be free of special surfactants and other stabilizers used for storage of diesel. In some embodiments, the oil-external emulsion can be a more stable emulsion than emulsions formed from diesel.

In various embodiments, the oil-external emulsion can include a proppant. In some embodiments, the oil-external emulsion can be used for combined proppant fracturing and fracture acidization, as well as asphaltene removal, a triple-stimulation combination that can result in increased recovery for lower cost and using a treatment that takes less time. In some embodiments, the oil-external emulsion can easily be configured to have a desired viscosity suitable for suspension of a wide variety of proppants, allowing for the more efficient and stable suspension of proppant under a wider variety of flow conditions than possible with other acidization compositions. In some embodiments, the oil-external emulsion including proppant can result in less proppant embedment than other stimulation or acidization techniques. In some embodiments, the oil-external emulsion including proppant can give less proppant over-displacement that other stimulation or acidization techniques. In some embodiments, the oil-external emulsion can be used to suspend gravel for gravel packing operations, allowing for simultaneous asphaltene removal, acidization, and gravel packing, and in some embodiments avoiding the application of breakers for removal of the composition once the gravel is placed in the desired location.

### BRIEF DESCRIPTION OF THE FIGURES

The drawings illustrate generally, by way of example, but not by way of limitation, various embodiments discussed in the present document.

FIG. 1a is a photograph of water having therein a portion of an emulsion composition including the emulsifier AF-70.

FIG. 1b is a photograph of a hydrocarbon solvent having therein a portion of an emulsion composition including the emulsifier AF-70.

FIG. 2a is a photograph of a hydrocarbon solvent having therein a portion of an emulsion composition including the emulsifier EZ MUL® NT, in accordance with various embodiments.

FIG. 2b is a photograph of water having therein a portion of an emulsion composition including the emulsifier EZ MUL® NT, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Selected substituents within the compounds described herein are present to a recursive degree. In this context, “recursive substituent” means that a substituent may recite another instance of itself or of another substituent that itself recites the first substituent. Recursive substituents are an intended aspect of the disclosed subject matter. Because of the recursive nature of such substituents, theoretically, a large number may be present in any given claim. One of ordinary skill in the art of organic chemistry understands that the total number of such substituents is reasonably limited by the desired properties of the compound intended. Such properties include, by way of example and not limitation, physical properties such as molecular weight, solubility, and practical properties such as ease of synthesis. Recursive substituents can call back on themselves any suitable number of times, such as about 1 time, about 2 times, 3, 4, 5, 6, 7, 8, 9, 10, 15, 20, 30, 50, 100, 200, 300, 400, 500, 750, 1000, 1500, 2000, 3000, 4000, 5000, 10,000, 15,000, 20,000, 30,000, 50,000, 100,000, 200,000, 500,000, 750,000, or about 1,000,000 times or more.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R′)₂, CN, NO, NO₂, ONO₂, azido, CF₃, OCF₃, R′, O(oxo), S(thiono), C(O), S(O), methylenedioxy, ethylenedioxy, N(R)₂, SR, SOR, SO₂R′, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R can be independently mono- or multi-substituted with J; or wherein two R groups bonded to a nitrogen atom or to adjacent nitrogen atoms can together with the nitrogen atom or atoms form a heterocyclyl, which can be mono- or independently multi-substituted with J.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The terms “halo” or “halogen” or “halide” group, as used herein, by themselves or as part of another substituent, mean, unless otherwise stated, a fluorine, chlorine, bromine, or iodine atom, preferably, fluorine, chlorine, or bromine

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof

The term “solvent” as used herein refers to a liquid that can dissolve a solid, liquid, or gas. Nonlimiting examples of solvents are silicones, organic compounds, water, alcohols, ionic liquids, and supercritical fluids.

The term “room temperature” as used herein refers to a temperature of about 15° C. to 28° C.

As used herein, the term “polymer” refers to a molecule having at least one repeating unit and can include copolymers.

The term “copolymer” as used herein refers to a polymer that includes at least two different monomers. A copolymer can include any suitable number of monomers.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid, or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidization treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “production fluid” refers to fluids or slurries used downhole during the production phase of a well. Production fluids can include downhole treatments designed to maintain or increase the production rate of a well, such as perforation treatments, clean-up treatments, or remedial treatments.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packing fluid” refers to fluids or slurries that can be placed in the annular region of a well between tubing and outer casing above a packer. In various examples, the packing fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidization, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore, or vice-versa. A flow pathway can include at least one of a hydraulic fracture, a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

### Method of Treating a Subterranean Formation.

In various embodiments, the present invention provides a method of treating a subterranean formation. The method includes obtaining or providing a composition including an oil-external water-internal emulsion. The emulsion can be an asphaltene-dissolving oil-external water-internal emulsion for acidization. The emulsion includes an asphaltene-dissolving composition, emulsifier, and aqueous acid. In various embodiments, the method includes a method of at least one of asphaltene dissolution and asphaltene deposit prevention, and also includes a method of at least one of acidization of the subterranean formation and acid fracturing the subterranean formation.

In some embodiments, the oil-external emulsion (e.g., water in oil emulsion) can have advantageous properties of acidization of subterranean formations. In various embodiments, acidization treatment with the oil-external emulsion can effectively increase the conductivity of fractures and flowpaths in the subterranean formation. For example, in addition to asphaltene-dissolving and asphaltene-deposit-preventing properties, in some embodiments the oil-external emulsion can be effective for producing wormholes while controlling the amount of formation softening that occurs during the acidization process. Controlling the amount of formation softening can include avoiding or decreasing the amount of formation softening, which can result in avoiding or decreasing negative effects associated with formation softening, such as loss of fracture conductivity. Embodiments of the present invention are not restricted to any particular mechanism of action. Since the acid is in the internal phase, an acid contacts the formation walls with lower frequency per volume of the emulsion than an un-emulsified aqueous acid solution or than a water-external emulsion, causing the emulsion to have a retarded acidization characteristic. In a hole in the surrounding formation, either already present or formed by acidization from the oil-external emulsion, the acid in the internal phase can be exposed to the inside of the hole with higher frequency than the acid in the internal phase contacts the formation walls overall, which can cause the emulsion to dissolving material in holes and form corresponding wormholes at a higher rate than the overall dissolution of the contacted formation walls, and to give longer wormholes. In various embodiments, the oil-external emulsion can dissolve a given mass of subterranean material in holes or wormholes at any suitably higher rate than the emulsion dissolves the same volume of material in the surrounding formation walls, such as about 0.01% higher or less, or about 0.1% higher, 1%, 2, 3, 4, 5, 10, 15, 20, 25, 30, 40, 50, 60, 70, 80, 90, 100, 110, 120, 130, 140, 150, 160, 170, 180, 190, 200, 220, 240, 260, 280, 300, 350, 400, 450, 500, 600, 700, 800, 900, or about 100% higher or more.

The obtaining or providing of the composition can occur at any suitable time and at any suitable location. The obtaining or providing of the composition can occur above the surface. The obtaining or providing of the composition can occur downhole. The method also includes placing the composition in a subterranean formation. The placing of the composition in the subterranean formation can include contacting the composition and any suitable part of the subterranean formation, or contacting the composition and a subterranean material downhole, such as any suitable subterranean material. The subterranean formation can be any suitable subterranean formation. In some examples, the placing of the composition in the subterranean formation includes contacting the composition with or placing the composition in at least one of an area desired to be acidized (e.g., matrix acidization or acid fracturing), a fracture, at least a part of an area surrounding a fracture, a flow pathway, an area surrounding a flow pathway, and an area desired to be fractured. The placing of the composition in the subterranean formation can be any suitable placing and can include any suitable contacting between the subterranean formation and the composition, wherein the oil-external emulsion can contact the subterranean formation. The placing of the composition in the subterranean formation can include at least partially depositing the composition in a fracture, flow pathway, or area surrounding the same.

The method can include hydraulic fracturing, such as a method of hydraulic fracturing to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). The method can include performing a stimulation treatment at least one of before, during, and after placing the composition in the subterranean formation in the fracture, flow pathway, or area surrounding the same. The stimulation treatment can be, for example, at least one of perforating, acidization, injecting of cleaning fluids, propellant stimulation, and hydraulic fracturing. In some embodiments, the stimulation treatment at least partially generates a fracture or flow pathway where the composition is placed or contacted, or the composition is placed or contacted to an area surrounding the generated fracture or flow pathway.

In various embodiments, the composition is placed in the subterranean formation at a pressure less than the fracture pressure of the subterranean formation. In other embodiments, the oil-external emulsion is placed in the subterranean formation at a pressure greater than the fracture pressure of the subterranean formation, causing fracturing of the subterranean formation and corresponding formation of one or more fractures, with simultaneous acidization and asphaltene-dissolving and asphaltene-deposit prevention. In some embodiments, the composition can include a proppant. The method can include depositing the proppant in one or more of the fractures formed.

In some embodiments, the composition can include gravel. The method can include a method of gravel packing. The composition including the gravel can be injected downhole to set the gravel in a desired location, with simultaneous acidization and asphaltene-dissolving and asphaltene-deposit prevention.

In some embodiments, before placing the composition including the oil-external emulsion downhole, the method can include placing an asphaltene-removing pre-acidizidation wash downhole. In other embodiments, the method is free of a pre-acidization wash. In some embodiments, after placing the oil-external emulsion downhole and corresponding acidization of the subterranean formation, the method can include a post-acidization backflush, to help remove the spent acidization composition.

In various embodiments, at least one of the composition and the oil-external emulsion is substantially free of diesel. In some embodiments, at least one of the composition and the oil-external emulsion is substantially free of organophilic clay. In some embodiments, at least one of the composition and the oil-external emulsion is substantially free of lignite.

At least one of the composition and the oil-external emulsion can have any suitable viscosity. For example, the viscosity at standard temperature and pressure, or under downhole conditions, can be about 0.01 cP to about 100,000 cP, or about 10 cP to about 15,000 cP, or about 0.01 cP or less, or about 0.02 cP, 0.05, 0.1, 0.5, 1, 5, 10, 25, 50, 75, 100, 150, 200, 300, 400, 500, 600, 700, 800, 900, 1,000, 1,100, 1,200, 1,300, 1,400, 1,500, 1,750, 2,000, 3,000, 4,000, 5,000, 7,500, 10,000, 12,500, 15,000, 20,000, 30,000, 40,000, 50,000, 60,000, 70,000, 80,000, 90,000, or about 100,000 cP or more. In some embodiments, at least one of the composition and the emulsion can have a viscosity at low shear, e.g., about 0 s⁻¹ to about 1 s⁻¹ or more, at standard temperature and pressure, or under downhole conditions, of about 0.01 cP to about 100,000 cP, or about 10 cP to about 15,000 cP, or about 0.01 cP or less, or about 0.02 cP, 0.05, 0.1, 0.5, 1, 5, 10, 25, 50, 75, 100, 150, 200, 300, 400, 500, 600, 700, 800, 900, 1,000, 1,100, 1,200, 1,300, 1,400, 1,500, 1,750, 2,000, 3,000, 4,000, 5,000, 7,500, 10,000, 12,500, 15,000, 20,000, 30,000, 40,000, 50,000, 60,000, 70,000, 80,000, 90,000, or about 100,000 cP or more. In some embodiments, at least one of the composition and the emulsion can have a viscosity at high shear, e.g., about 500 s⁻¹ or less to about 1000 s⁻¹ or more, at standard temperature and pressure, or under downhole conditions, of about 0.01 cP to about 100,000 cP, or about 10 cP to about 15,000 cP, or about 0.01 cP or less, or about 0.02 cP, 0.05, 0.1, 0.5, 1, 5, 10, 25, 50, 75, 100, 150, 200, 300, 400, 500, 600, 700, 800, 900, 1,000, 1,100, 1,200, 1,300, 1,400, 1,500, 1,750, 2,000, 3,000, 4,000, 5,000, 7,500, 10,000, 12,500, 15,000, 20,000, 30,000, 40,000, 50,000, 60,000, 70,000, 80,000, 90,000, or about 100,000 cP or more.

The internal phase of the oil-external emulsion can be any suitable proportion of the emulsion by volume. For example, the internal phase can be about 50% to about 90% of the oil-external emulsion by volume, about 60% to about 80% of the oil-external emulsion by volume, or about 50% or less, or about 55%, 60, 65, 70, 75, 80, 85, or about 90% or more. The external phase of the oil-external emulsion can be any suitable proportion of the emulsion by volume. For example, the external phase can be about 10% to about 50% of the oil-external emulsion by volume, or about 20% to about 40%, or about 10% or less, or about 15%, 20, 25, 30, 35, 40, 45, or about 50% or more.

### Asphaltene-Dissolving Composition.

The oil-external emulsion includes an asphaltene-dissolving composition. The asphaltene-dissolving composition can be any suitable asphaltene-dissolving composition, such that the emulsion can be used as described herein. The external phase of the emulsion can include the asphaltene-dissolving composition. In some embodiments, the asphaltene-dissolving composition can be substantially free of at least one of benzene, toluene, ethylbenzene, and xylenes. In some embodiments, the asphaltene-dissolving composition can include at least one of benzene, toluene, ethylbenzne, and xylenes. In some embodiments, 1 wt % to about 100 wt % of the external phase of the emulsion is the asphaltene-dissolving composition, or about 50 wt % to about 100 wt %, or about 1 wt % or less, or about 5 wt %, 10, 15, 20, 25, 30, 35, 40, 45, 50, 55, 60, 65, 70, 75, 80, 85, 90, 95, or about 100 wt % of the external phase of the emulsion is the asphaltene-dissolving composition.

The asphaltene-dissolving composition can include an aromatic hydrocarbon composition. The aromatic hydrocarbon composition can be any suitable proportion of the oil-external emulsion. In some embodiments, the aromatic hydrocarbon composition is about 1 wt % to about 80 wt % of the emulsion, or about 10 wt % to about 30 wt %, or about 1 wt % or less, or about 5 wt %, 10, 12, 14, 16, 18, 20, 22, 24, 26, 28, 30, 35, 40, 45, 50, 55, 60, 65, 70, 75, or about 80 wt % or more of the emulsion is the aromatic hydrocarbon composition. The aromatic hydrocarbon composition can be any suitable proportion of the asphaltene-dissolving composition. In some embodiments, the aromatic hydrocarbon composition is about 10 wt % to about 100 wt % of the asphaltene-dissolving composition is the aromatic hydrocarbon composition, or about 50 wt % to about 100 wt %, or about 10 wt % or less, or about 20 wt %, 25, 30, 35, 40, 45, 50, 55, 60, 65, 70, 75, 80, 85, 90, 95, or about 100 wt % or more of the asphaltene-dissolving composition is the aromatic hydrocarbon composition.

The asphaltene-dissolving composition can be any suitable aromatic hydrocarbon composition. In some embodiments, the aromatic hydrocarbon composition can be substantially free of at least one of benzene, toluene, ethylbenzene, and xylenes. In some embodiments, the aromatic hydrocarbon composition can include at least one of benzene, toluene, ethylbenzne, and xylenes. In some embodiments, the aromatic hydrocarbon composition includes aromatic petroleum naptha. The aromatic hydrocarbon composition or the aromatic petroleum naptha can include a mono or poly(C₀-C₁₀)alkyl-substituted (C₅-C₃₀)aromatic hydrocarbon ring system, wherein each alkyl is independently substituted or unsubstituted, and wherein each aromatic ring is independently substituted or unsubstituted. The aromatic hydrocarbon composition or the aromatic petroleum naptha can include at least one of mono(C₁-C₁₀)alkyl-substituted benzene, poly(C₁-C₁₀)alkyl-substituted benzene, mono(C₁-C₁₀)alkyl-substituted naphthalene, and poly(C₁-C₁₀)alkyl-substituted naphthalene. The aromatic hydrocarbon composition or the aromatic petroleum naptha can include heavy aromatic petroleum naphtha, e.g., having a boiling point range of about 165° C. to about 290° C. The aromatic hydrocarbon composition can include any suitable proportion of the aromatic petroleum naptha, such as about 5 wt % to about 100 wt % aromatic petroleum naptha, or about 60 wt % to about to about 100 wt %, or about 5 wt % or less, or about 10 wt %, 15, 20, 25, 30, 35, 40, 45, 50, 55, 60, 65, 70, 75, 80, 85, 90, 95, 96, 97, 98, 99, or about 100 wt % aromatic petroleum naptha. In some embodiments, about 60 wt % to about 100 wt % of the aromatic hydrocarbon composition is heavy aromatic petroleum naphtha.

The aromatic hydrocarbon composition can include a C₁₀-C₂₂ compound that is fused aromatic hydrocarbon rings. The C₁₀-C₂₂ compound can be at least one of naphthalene, anthracene, phenanthrene, chrysene, and pyrene. In some embodiments, about 0.1 wt % to about 40 wt % of the aromatic hydrocarbon composition is the C₁₀-C₂₂ compound, or about 2 wt % to about 20 wt %, or about 0.1 wt % or less, or about 1 wt %, 2, 3, 4, 5, 6, 7, 8, 9, 10, 12, 15, 18, 20, 25, 30, 35, or about 40 wt % of the aromatic hydrocarbon composition is the C₁₀-C₂₂ compound. In some embodiments, about 5 wt % to about 10 wt % of the aromatic hydrocarbon composition is naphthalene.

The aromatic hydrocarbon composition can include at least one of a di(C₁-C₅)alkylbenzene and a tri(C₁-C₅)alkylbenzene, such as at least one of trimethylbenzene, triethylbenzene, dimethylbenzene, diethylbenzene, methylethylbenzene, dimethylethylbenzene, and diethylmethylbenzene, having substitution patterns of at least one of 1,2-, 1,3-, 1,4-, 1,2,3-, 1,2,4-, 1,2,5-, 1,3,5-, and 1,3,6-. In some embodiments, about 0.1 wt % to about 20 wt % of the aromatic hydrocarbon composition is at least one of a di(C₁-C₅)alkylbenzene and a tri(C₁-C₅)alkylbenzene, or about 0.5 wt % to about 10 wt %, or about 0.5 wt % or less, or about 1 wt %, 2, 3, 4, 5, 6, 7, 8, 9, 10, 12, 14, 16, 18, or about 20 wt % or more. In some embodiments, about 1 wt % to about 5 wt % of the aromatic hydrocarbon composition is 1,2,4-trimethylbenzene.

The aromatic hydrocarbon composition can be Paragon™ 100 E+. For example, about 60 wt % to about 100 wt % of the aromatic hydrocarbon composition can be heavy aromatic petroleum naphtha, about 5 wt % to about 10 wt % of the aromatic hydrocarbon composition can be naphthalene, and about 1 wt % to about 5 wt % of the aromatic hydrocarbon composition can be 1,2,4-trimethylbenzene.

In some embodiments, the aromatic hydrocarbon composition includes xylenes, or includes at least one of 1,2-dimethylbenzene, 1,3-dimethylbenzene, and 1,4-dimethylbenzene, such as about 10 wt % to about 100 wt % of the aromatic hydrocarbon composition, or about 30 wt % to about 100 wt %, or about 10 wt % or less, or about 20 wt %, 30, 40, 50, 60, 70, 80, 90, or about 100 wt % of the aromatic hydrocarbon composition. In some embodiments, about 60-100 wt % of the aromatic hydrocarbon composition is xylenes.

In some embodiments, the aromatic hydrocarbon composition includes a (C₁-C₅)alkylbenzene, such as ethylbenzene. For example, about 1 wt % to about 80 wt % of the aromatic hydrocarbon composition can be the (C₁-C₅)alkylbenzene, or about 5 wt % to about 60 wt %, or about 1 wt % or less, or about 5, 10, 15, 20, 25, 30, 35, 40, 45, 50, 55, 60, 65, 70, 75, or about 80 wt % or more of the composition can be the (C₁-C₅)alkylbenzene. In some embodiments, about 10 wt % to about 30 wt % of the aromatic hydrocarbon composition is ethylbenzene.

The aromatic hydrocarbon composition can be Paragon™. For example, about 60-100 wt % of the aromatic hydrocarbon composition is xylenes, and about 10 wt % to about 30 wt % of the aromatic hydrocarbon composition is ethylbenzene.

In various embodiments, the asphaltene-dissolving composition can include one or more polar organic solvents that are miscible with the aromatic hydrocarbon composition. The polar organic solvent can be any suitable polar organic solvent such that the emulsion can be used as described herein. The polar organic solvent can be a solvent designed for asphaltene dissolution and can give the asphaltene-dissolving composition of the emulsion asphaltene-dissolving properties. For example, the polar organic solvent can be at least one of acetone, chloroform, cichloromethane, tetrahydrofuran, ethyl acetate, acetone, dimethylformamide, acetonitrile, dimethyl sulfoxide, propylene carbonate, formic acid, n-butanol, isopropanol, n-propanol, ethanol, methanol, acetic acid, nitromethane, or N-methylpyrrolidone. Any suitable proportion of the oil-external emulsion can be the polar organic solvent. In some embodiments, about 0.01 wt % to about 90 wt % of the emulsion is the one or more polar organic solvents, or about 0.1 wt % to about 5 wt %, or about 0.01 wt % or less, or about 0.05 wt %, 0.1, 0.5, 1, 1.2, 1.4, 1.6, 1.8, 2.0, 2.2, 2.4, 2.6, 2.8, 3, 3.5, 4, 5, 6, 7, 8, 9, 10, 15, 20, 25, 30, 35, 40, 45, 50, 55, 60, 65, 70, 75, 80, 85, or about 90 wt % or more of the emulsion is the one or more polar organic solvents. Any suitable proportion of the asphaltene-dissolving composition can be the polar organic solvent. In some embodiments, about 0.001 wt % to about 90 wt % of the asphaltene-dissolving composition is the one or more polar organic solvents, or about 0.1 wt % to about 20 wt %, or about 0.001 wt % or less, or about 0.005 wt %, 0.01, 0.05, 0.1, 0.5, 1, 2, 4, 6, 8, 10, 12, 14, 16, 18, 20, 22, 24, 26, 28, 30, 35, 40, 45, 50, 55, 60, 65, 70, 75, 80, 85, or about 90 wt % or more of the asphaltene-dissolving composition can be one or more polar organic solvents. In some embodiments, about 0.1 wt % to about 5 wt % of the asphaltene-dissolving composition is the polar organic solvent. In some embodiments, the polar organic solvent includes Targon™ II; for example, about 30 wt % to about 100 wt % of the polar organic solvent can be N-methylpyrrolidone.

### Emulsifier.

The oil-external emulsion includes an emulsifier. The emulsifier can be any suitable proportion of the emulsion, such that the oil-external emulsion can be formed and can be used as described herein. For example, the emulsifier can be about 0.001 wt % to about 25 wt % of the emulsion, or about 0.01 to about 10 wt %, or about 0.1 wt % to about 5 wt %, or about 0.001 wt % or less, or about 0.01 wt %, 0.05, 0.1, 0.2, 0.4, 0.6, 0.8, 1, 1.2, 1.4, 1.6, 1.8, 2, 2.2, 2.4, 2.6, 2.8, 3, 3.2, 3.4, 3.6, 3.8, 4, 4.5, 5, 6, 7, 8, 9, 10, 15, 20, or about 25 wt % or more of the oil-external emulsion.

The emulsifier can be any suitable emulsifier, such that the oil-external emulsion can be formed and can be used as described herein. In some embodiments, the emulsifier can be at least one of a sulfate, sulfonate, phosphate, carboxylate, tri(C₁-C₁₀)alkylammonium halide, substituted or unsubstituted fatty alcohol, substituted or unsubstituted fatty acid, substituted or unsubstituted fatty acid ester, and a substituted or unsubstituted poly((C₁-C₁₀)hydrocarbylene oxide) independently having H or (C₁-C₁₀)hydrocarbylene as end-groups. In some embodiments, the emulsifier can be ammonium aluryl sulfate, sodium lauryl sulfate, sodium laureth sulfate, sodium myreth sulfate, dioctyl sodium sulfosuccinate, perfluorooctanesulfonate, perfluorobutanesulfonate, linear (C₁-C₁₀)alkylbenzene sulfonate, sodium stearate, sodium lauroyl sarcosinate, perfluorononanoate, perfluorooctanoate, octenidine dihydrochloride, cetyl trimethylammonium bromide, cetyl trimethylammonium chloride, cetylpyridinium chloride, benzalkonium chloride, benzethonium chloride, 5-bromo-5-nitro-1,3-dioxane, dimethyldiactadecylammonium chloride, cetrimonium bromide, dioctadecyldimethylammonium bromide, 3-[(3-cholamidopropyl) dimethylammonio]-1-propanesulfonate, cocamidopropyl hydroxysultaine, cocamidopropyl betaine, lecithin, a polyoxyethylene glycol alkyl ether (e.g. octaethylene glycol monododecyl ether, pentaethylene glycol monododecyl ether), a polyoxypropylene glycol ether, a glucoside alkyl ether (e.g., decyl glucoside, lauryl glucoside, octyl glucoside), a polyoxyethylene glycol octylphenol ether (e.g., triton X-100), a polyoxyethylene glycol alkylphenol ether (e.g., nonoxynol-9), a glycerol alkyl ether (e.g., glyceryl laurate), a polyoxyethylene glycol sorbitan alkyl ester (e.g., polysorbate, such as polyoxyethylene (20) sorbitan monolaurate, or monopalmitate, or monosterate, or monooleate), cocamide monoethanolamine, cocamide diethanolamine, dodecyldimethylaminde oxide, a poloxamer, and a polyethoxylated tallow amine

The emulsifier can include at least one of a polyaminated fatty acid and a polyaminated fatty acid alkyl ester, for example, at least one of a polyaminated (C₃-C₅₀)fatty acid and a polyaminated (C₃-C₅₀)fatty acid (C₁-C₁₀) alkyl ester. About 1 wt % to about 100 wt % of the emulsifier can be at least one of a polyaminated fatty acid and a polyaminated fatty acid alkyl ester, or about 50 to about 90 wt %, or about 1 wt % or less, or about 5, 10, 15, 20, 25, 30, 35, 40, 45, 50, 55, 60, 65, 70, 75, 80, 85, or about 90 wt % or more.

In some embodiments, the emulsifier includes ethylene glycol monobutyl ether, such as about 0.01 wt % to about 20 wt % ethylene glycol monobutyl ether, or about 1 wt % to about 5 wt %, or about 0.01 wt % or less, or about 0.1 wt %, 1, 2, 3, 4, 5, 6, 7, 8, 9, 10, 12, 14, 16, 18, or about 20 wt % or more.

In some embodiments, the emulsifier includes diethylene glycol monobutyl ether, such as about 0.01 wt % to about 20 wt % diethylene glycol monobutyl ether, or about 1 wt % to about 5 wt %, or about 0.01 wt % or less, or about 0.1 wt %, 1, 2, 3, 4, 5, 6, 7, 8, 9, 10, 12, 14, 16, 18, or about 20 wt % or more.

The emulsifier can include a petroleum distillate, such as a hydrotreated light petroleum distillate. In some embodiments, the emulsifier includes about 1 wt % to about 90 wt % hydrotreated light petroleum distillate, or about 10 wt % to about 30 wt % hydrotreated light petroleum distillate, or about 1 wt % or less, or about 5, 10, 15, 20, 25, 30, 35, 40, 45, 50, 55, 60, 65, 70, 75, 80, 85, or about 90 wt % or more.

In some embodiments, the emulsifier can include EZ MUL® NT; for example, the emulsifier can include about 60 wt % to about 97 wt % polyaminated fatty acids, about 10 wt % to about 30 wt % hydrotreated light petroleum distillate, about 1 wt % to about 5 wt % ethylene glycol monobutyl ether, and about 1 wt % to about 5 wt % diethylene glycol monobutyl ether.

In some embodiments, the emulsifier can have a Davies' scale hydrophilic-liphophilic balance (HLB) of about 3 to about 7, or about 3 to about 5, about 4 to about 7, about 4 to about 6, or about such as about 2 or less, or about 2.5, 3, 3.5, 4, 4.5, 5, 5.5, 6, 6.5, 7, 7.5, or about 8 or more.

In some embodiments, the emulsifier can have a Griffin's index HLB of about 7 to about 11, or about 7 to about 10, or about 9 to about 11, or about 8 to about 10, or about 6 or less, or about 6.5, 7, 7.5, 8, 8.5, 9, 9.5, 10, 10.5, 11, 11.5, or about 12 or more.

### Acid.

The oil-external emulsion includes an aqueous acid. The aqueous acid is a solution of water and acid. The aqueous acid can be the internal phase of the oil-external emulsion. The aqueous acid can be any suitable proportion of the emulsion. In some embodiments, the emulsion is about 10 wt % to about 99 wt % of the aqueous acid, or about 40 wt % to about 90 wt %, or about 10 wt % or less, or about 15 wt %, 20, 25, 30, 35, 40, 45, 50, 55, 60, 65, 70, 75, 80, 85, or about 90 wt % or more of the aqueous acid. The aqueous acid can be any suitable aqueous acid. The aqueous acid can have any suitable concentration of acid therein, such as about 0.1 wt % acid to about 99 wt % acid, about 5 wt % to about 50 wt % acid, or about 0.1 wt % or less, or about 1 wt %, 2, 3, 4, 5, 10, 15, 20, 25, 30, 35, 40, 45, 50, 55, 60, 65, 70, 75, 80, 85, 90, 95, 96, 97, 98, or about 99 wt % or more acid. The acid can be any suitable acid. For example, the acid can be at least one of hydrochloric acid, sulfuric acid, fluoric acid, nitric acid, phosphoric acid, boric acid, hydrobromic acid, perchloric acid, acetic acid, formic acid, lactic acid, citric acid, oxalic acid, uric acid, glutaric acid, glutamic acid, adipic acid, and phthalic acid. The aqueous acid can have any suitable pH, such that the oil-external emulsion can be used as described herein. For example, the aqueous acid can have an initial pH, prior to substantial dissolution of a portion of the subterranean formation and corresponding formation of wormholes, of about −20 to about 6, or about −2 to about 3, or about −20 or less, or about −19, −18, −17, −16, −15, −14, −13, −12, −11, −10, −9, −8, −7, −6, −5, −4, −3, −2, −1, 0, 1, 2, 3, 4, 5, 6, 6.5, 6.6, 6.7, 6.8, or about 6.9 or more.

### Additional Components

The oil-external emulsion and the composition including the oil-external emulsion can include any suitable component.

The external phase can include any suitable oil-soluble liquid, such as at least one of diesel, a mineral oil, a synthetic oil, a paraffin oil, an olefinic hydrocarbon, an aromatic hydrocarbon, and a glyceride triester.

In some embodiments, at least one of the composition and the emulsion can include a polymer. The polymer can be any suitable polymer. The polymer can be a water soluble polymer that is predominantly in the internal aqueous phase of the emulsion, or the polymer can be an oil-solution polymer that is predominantly in the external oil phase of the emulsion. In some embodiments, the external phase includes an oil-soluble polymer.

In some embodiments, at least one of the composition and the emulsion can include a corrosion inhibitor. The corrosion inhibitor can be any suitable corrosion inhibitor. The corrosion inhibitor can be a water soluble corrosion inhibitor that is predominantly in the internal aqueous phase of the emulsion, or the corrosion inhibitor can be an oil soluble corrosion inhibitor that is predominantly in the internal phase of the emulsion. In some embodiments, the external phase of the emulsion includes a corrosion inhibitor. In some examples, the corrosion inhibitor is at least one of acetylenic alcohols, Mannich condensation products, unsaturated carbonyl compounds, unsaturated ether compounds, formamide, formic acid, formates, other sources of carbonyl, iodides, terpenes, and aromatic hydrocarbons, coffee, tobacco, gelatin, cinnamaldehyde, cinnamaldehyde derivatives, acetylenic alcohols, fluorinated surfactants, quaternary derivatives of heterocyclic nitrogen bases, quaternary derivatives of halomethylated aromatic compounds, combinations of such compounds used in conjunction with iodine, and quaternary ammonium compounds.

In some embodiments, the internal phase can include at least one salt. The salt can be any suitable salt. In some examples, the internal phase of the emulsion is made using brine, brackish water, sea water, produced water, or flowback water. In some examples, the salt is at least one of calcium chloride, sodium chloride, potassium chloride, magnesium chloride, calcium bromide, sodium bromide, potassium bromide, calcium nitrate, sodium formate, potassium formate, and cesium formate. The salt can be at any suitable concentration, such as about 5 ppmw to about 200,000 ppmw, or about 100 ppmw to about 7,000 ppmw, or about 5 ppmw or less, or about 10 ppmw, 50, 100, 500, 1000, 5,000, 10,000, 15,000, 20,000, 50,000, 75,000, 100,000, 150,000, or about 200,000 ppmw or higher. In some embodiments, the internal phase can include Na⁺ ions at any suitable concentration, such as about 5 ppmw to about 200,000 ppmw, or about 100 ppmw to about 7,000 ppmw, or about 5 ppmw or less, or about 10 ppmw, 50, 100, 500, 1000, 5,000, 10,000, 15,000, 20,000, 50,000, 75,000, 100,000, 150,000, or about 200,000 ppmw or higher. In some embodiments, the internal phase can include Cl⁻ ions at any suitable concentration, such as about 10 ppmw to about 400,000 ppmw, about 200 ppmw to about 14,000 ppmw, or about 10 ppmw or less, or about 20, 50, 100, 200, 500, 1,000, 2,500, 5,000, 7,500, 10,000, 12,500, or about 14,000 ppmw or more. In some embodiments, the internal phase can include K⁺ ions at any suitable concentration, such as about 1 ppmw to about 70,000 ppmw, about 40 ppmw to about 2,500 ppmw, or about 1 ppmw or less, or about 10 ppmw, 20, 50, 100, 200, 500, 1,000, 2,500, 5,000, 10,000, 15,000, 20,000, 25,000, 50,000, or about 70,000 ppmw or more. In some examples, the internal phase can include Ca²⁺ ions at any suitable concentration, such as about 1 to about 70,000, or about 40 to about 2,500, or about 1 ppmw or less, or about 10 ppmw, 20, 50, 100, 200, 500, 1,000, 2,500, 5,000, 10,000, 15,000, 20,000, 25,000, 50,000, or about 70,000 ppmw or more. In some embodiments, the internal phase can include Br⁻ ions at any suitable concentration, such as about 0.1 ppmw to about 12,000 ppmw, or about 5 ppmw to about 450 ppmw.

In some embodiments, at least one of the oil-external emulsion and the composition including the oil-external emulsion can include a viscosifier. The viscosifier can be any suitable viscosifier. The viscosifier can cause viscosification at least one of upon addition, over time, after a delay, and in response to a stimulus such as addition of a crosslinker or activation of a crosslinker. In some examples, the viscosifier can be a crosslinked gel or a crosslinkable gel, such as any suitable crosslinked gel or crosslinkable gel. For example, the crosslinked gel or crosslinkable gel can be at least one of a linear polysaccharide and a poly((C₂-C₁₀)alkenylene), wherein the (C₂-C₁₀)alkenylene is substituted or unsubstituted. The gel or crosslinked gel can include least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), acetan, alginate, chitosan, curdlan, a cyclosophoran, dextran, emulsan, a galactoglucopolysaccharide, gellan, glucuronan, N-acetyl-glucosamine, N-acetyl-heparosan, hyaluronic acid, indicant, kefiran, lentinan, levan, mauran, pullulan, scleroglucan, schizophyllan, stewartan, succinoglycan, xanthan, welan, starch, tamarind, tragacanth, guar gum, derivatized guar, gum ghatti, gum arabic, locust bean gum, cellulose, and derivatized cellulose. The gel or crosslinked gel can include cellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar. The gel or crosslinked gel can form any suitable proportion of the composition or the oil-external emulsion, such as about 0.001 wt % to about 10 wt %, 0.01 wt % to about 0.6 wt %, about 0.13 wt % to about 0.30 wt %, or about 0.001 wt % or less, or about 0.005 wt %, 0.01, 0.05, 0.1, 0.2,0.3, 0.4, 0.5, 0.6, 0.7, 0.8, 0.9, 1, 1.5, 2, 3, 4, 5, 6, 7, 8, 9, or about 10 wt % of the composition or oil-external emulsion.

At least one of the composition and the oil-external emulsion can include a crosslinker. The crosslinker can be any suitable crosslinker, such as a crosslinker suitable for crosslinking a crosslinkable or at least partially crosslinked gel in the composition or oil-external emulsion. For example, the crosslinker can include at least one of chromium, aluminum, antimony, zirconium, titanium, calcium, boron, iron, silicon, copper, zinc, magnesium, and an ion thereof The crosslinker can include at least one of boric acid, borax, a borate, a (C₁-C₃₀)hydrocarbylboronic acid, a (C₁-C₃₀)hydrocarbyl ester of a (C₁-C₃₀) hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, and zirconium lactate glycolate, titanium lactate, titanium malate, titanium citrate, titanium ammonium lactate, titanium triethanolamine, titanium acetylacetonate, aluminum lactate, or aluminum citrate. The crosslinker can be present in any suitable proportion of the oil-external emulsion or the composition, such as about 0.000,001 wt % to about 5 wt %, about 0.001 wt % to about 2 wt %, or about 0.000,001 wt % or less, or about 0.000,01 wt %, 0.000, 1, 0.001, 0.01, 0.1, 1, 1.5, 2, 2.5, 3, 3.5, 4, 4.5, or about 5 wt % of the composition or oil-external emulsion or more. The method can include crosslinking the gel or the crosslinked gel. In some embodiments, the crosslinking occurs above the surface. In some embodiments, the crosslinking occurs downhole, such as during or after placement of the composition in the subterranean formation.

In various embodiments, at least one of the composition and the emulsion includes one or more additives such as: thinner additives such as COLDTROL®, ATC®, OMC 2™, and OMC 42™; RHEMOD™, a viscosifier and suspension agent including a modified fatty acid; additives for providing temporary increased viscosity, such as for shipping (e.g., transport to the well site) and for use in sweeps, for example, additives having the tradename TEMPERUS™ (a modified fatty acid) and VIS-PLUS®, a thixotropic viscosifying polymer blend; TAU-MOD™, a viscosifying/suspension agent including an amorphous/fibrous material; additives for filtration control, for example, additives having the tradename ADAPTA®, a HTHP filtration control agent including a crosslinked copolymer; DURATONE® HT, a filtration control agent that includes an organophilic lignite, more particularly organophilic leonardite; THERMO TONE™, a high temperature high pressure (HTHP) filtration control agent including a synthetic polymer; BDF™-366, a HTHP filtration control agent; BDF™-454, a HTHP filtration control agent; LIQUITONE™, a polymeric filtration agent and viscosifier; additives for HTHP emulsion stability, for example, FACTANT™, which includes highly concentrated tall oil derivative; emulsifiers such as LE SUPERMUL™ and EZ MUL® NT, polyaminated fatty acid emulsifiers, and FORTI-MUL®; DRIL TREAT®, an oil wetting agent for heavy fluids; BARACARB®, a bridging agent which includes a sized calcium carbonate (ground marble); BAROID®, a weighting agent that includes barium sulfate; BAROLIFT®, a hole sweeping agent; SWEEP-WATE®, a sweep weighting agent; BDF-508, a diamine dimer rheology modifier; GELTONE® II organophilic clay; BAROFIBRE™ O for lost circulation management and seepage loss prevention, including a natural cellulose fiber; STEELSEAL®, a lost circulation material including a polymer; lime, which can provide alkalinity and can activate certain emulsifiers; and calcium chloride, which can provide salinity.

In some embodiments, at least one of the composition and the oil-external emulsion can include any suitable amount of any suitable material used in a downhole fluid. For example, at least one of the composition and oil-external emulsion can include water, saline, aqueous base, oil, organic solvent, synthetic fluid oil phase, aqueous solution, alcohol or polyol, cellulose, starch, alkalinity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, dispersants, salts, fibers, thixotropic additives, breakers, crosslinkers, rheology modifiers, curing accelerators, curing retarders, pH modifiers, chelating agents, scale inhibitors, enzymes, resins, water control materials, oxidizers, markers, metakaolin, shale, zeolite, a crystalline silica compound, amorphous silica, hydratable clays, microspheres, pozzolan lime, or a combination thereof

### Downhole Mixture or Composition.

The composition including only the oil-external emulsion or including the oil-external emulsion in combination with any other suitable components or materials can be combined with any suitable downhole fluid before, during, or after the placement of the composition in the subterranean formation or the contacting of the composition and the subterranean material. In some examples, the composition including the oil-external emulsion is combined with a downhole fluid above the surface, and then the combined composition is placed in a subterranean formation or contacted with a subterranean material. In another example, the composition including the oil-external emulsion is injected into a subterranean formation to combine with a downhole fluid, and the combined composition is contacted with a subterranean material or is considered to be placed in the subterranean formation. In various examples, at least one of prior to, during, and after the placement of the composition in the subterranean formation or contacting of the subterranean material and the composition, the composition is used downhole, at least one of alone and in combination with other materials, as a drilling fluid, stimulation fluid, fracturing fluid, spotting fluid, clean-up fluid, production fluid, completion fluid, remedial treatment fluid, abandonment fluid, pill, acidizing fluid, packer fluid, or a combination thereof

In various embodiments, the method includes combining the composition including the oil-external emulsion with any suitable downhole fluid, such as an aqueous or oil-based fluid including a drilling fluid, stimulation fluid, fracturing fluid, spotting fluid, clean-up fluid, production fluid, completion fluid, remedial treatment fluid, abandonment fluid, pill, acidizing fluid, packer fluid, or a combination thereof, to form a mixture. The placement of the composition in the subterranean formation can include contacting the subterranean material and the mixture. The contacting of the subterranean material and the composition can include contacting the subterranean material and the mixture. A mixture that is placed in the subterranean formation or contacted with the subterranean material can include any suitable weight percent of the composition including the oil-external emulsion, such as about 0.000,000,01 wt % to 99.999,99 wt %, 0.000,1-99.9 wt %, 0.1 wt % to 99.9 wt %, or about 20-90 wt %, or about 0.000,000,01 wt % or less, or about 0.000,001 wt %, 0.000,1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999, 99.999,9, or about 99.999,99 wt % or more of the composition.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill head as well as reduce friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake which temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g. barium sulfate), surfactants (e.g. betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g. silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture. The drilling fluid can be present in the mixture with the composition including the oil-external emulsion in any suitable amount, such as about 1 wt % or less, about 2 wt %, 3, 4, 5, 10, 15, 20, 30, 40, 50, 60, 70, 80, 85, 90, 95, 96, 97, 98, 99, 99.9, 99.99, 99.999, or about 99.9999 wt % or more of the mixture.

An oil-based drilling fluid or mud in embodiments of the present invention can be any suitable oil-based drilling fluid. In various embodiments the drilling fluid can include at least one of an oil-based fluid (or synthetic fluid), saline, aqueous solution, emulsifiers, other agents of additives for suspension control, weight or density control, oil-wetting agents, fluid loss or filtration control agents, and rheology control agents. For example, see H. C. H. Darley and George R. Gray, Composition and Properties of Drilling and Completion Fluids 66-67, 561-562 (5^{th} ed. 1988). An oil-based or invert emulsion-based drilling fluid can include between about 10:90 to about 95:5, or about 50:50 to about 95:5, by volume of oil phase to water phase. A substantially all oil mud includes about 100% liquid phase oil by volume (e.g., substantially no internal aqueous phase).

A pill is a relatively small quantity (e.g. less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

In various embodiments, the present invention can include a proppant, a resin-coated proppant, an encapsulated resin, or a combination thereof. A proppant is a material that keeps an induced hydraulic fracture at least partially open during or after a fracturing treatment. Proppants can be transported downhole to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant. In some embodiments, proppant can have an average particle size of about 0.15 mm to about 2.5 mm, about 0.25-0.43 mm, 0.43-0.85 mm, 0.85-1.18 mm, 1.18-1.70 mm, and 1.70-2.36 mm.

The composition can include a payload material. The payload can be deposited in any suitable downhole location. The method can include using the composition to deposit a payload material into a subterranean fracture. The subterranean fracture can be any suitable subterranean fraction. In some embodiments, the method includes forming the subterranean fracture; in other embodiments, the subterranean fracture is already formed. The payload material can be a proppant, or any other suitable payload material, such as a resin-coated proppant, a curable material, an encapsulated resin, a resin, fly ash, metakaolin, shale, zeolite, a set retarding additive, a surfactant, a gas, an accelerator, a weight reducing additive, a heavy-weight additive, a lost circulation material, a filtration control additive, a dispersant, a crystalline silica compound, an amorphous silica, a salt, a fiber, a hydratable clay, a microsphere, pozzolan lime, a thixotropic additive, water, an aqueous base, an aqueous acid, an alcohol or polyol, a cellulose, a starch, an alkalinity control agent, a density control agent, a density modifier, a surfactant, an emulsifier, a dispersant, a polymeric stabilizer, a crosslinking agent, a polyacrylamide, a polymer or combination of polymers, an antioxidant, a heat stabilizer, a foam control agent, a solvent, a diluent, a plasticizer, a filler or inorganic particle, a pigment, a dye, a precipitating agent, a rheology modifier, or a combination thereof.

### System.

In various embodiments, the present invention provides a system. The system can include a composition including an oil-external water-internal emulsion, such as any oil-external emulsion described herein. The oil-external emulsion can include an asphaltene-dissolving composition, an emulsifier, and an aqueous acid. The system can also include a subterranean formation including the composition therein. In some embodiments, the composition in the system can also include a downhole fluid.

### Composition for Treatment of a Subterranean Formation.

Various embodiments provide a composition for treatment of a subterranean formation. The composition can be any suitable composition that can be used to perform an embodiment of the method for treatment of a subterranean formation described herein.

For example, the composition can include an oil-external water-internal emulsion, such as any oil-external emulsion described herein. The oil-external water-internal emulsion can include an asphaltene-dissolving composition, emulsifier, and aqueous acid.

In some embodiments, the composition further includes a downhole fluid. The downhole fluid can be any suitable downhole fluid. In some embodiments, the downhole fluid is a composition for fracturing of a subterranean formation or subterranean material, or a fracturing fluid.

In some embodiments, the oil-external emulsion includes an external phase that is about 10% to about 50% of the oil-external emulsion by volume. The external phase can include an asphaltene-dissolving composition that includes heavy aromatic petroleum naptha and a polar organic compound miscible with the heavy aromatic petroleum naptha. The emulsion can also include an internal phase that is about about 50% to about 90% of the emulsion by volume. The internal phase can include aqueous acid. The emulsion can also include an emulsifier including a polyaminated fatty acid.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a composition including an oil-external water-internal emulsion. The emulsion can be any oil-external emulsion described herein. The emulsion can include an asphaltene-dissolving composition, emulsifier, and aqueous acid.

### Examples

The present invention can be better understood by reference to the following examples which are offered by way of illustration. The present invention is not limited to the examples given herein.

Paragon™ 100 E+, Targon™ II, AF-70, and EZ MUL® NT are available from Halliburton.

### Example 1. Comparative

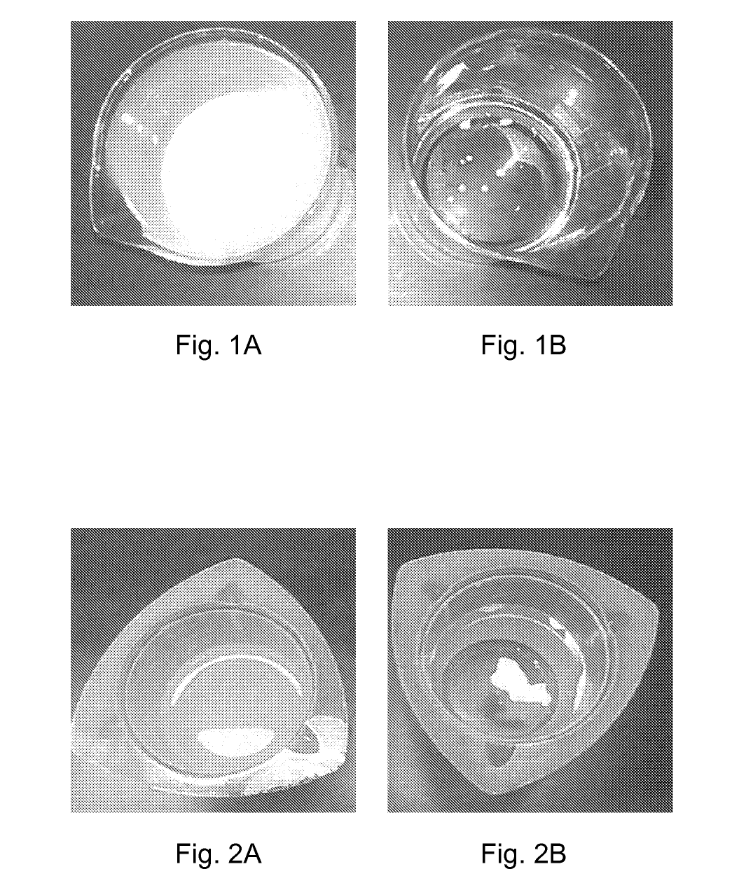

An emulsion was formed having 23.9 wt % Paragon™ 100 E+, 2.1 wt % Targon™ II, 2.0 wt % AF-70 emulsifier, and 72% water. When a portion of the composition was added to water (FIG. 1a), the composition dispersed, indicating a water-external phase. When a portion of the composition was added to Paragon 100 E+ (FIG. 1b), the composition remained as a bead, again indicating a water-external phase.

### Example 2

An emulsion was formed having 23.9 wt % Paragon™ 100 E+, 2.1 wt % Targon™ II, 2.0 wt % EZ MUL® NT emulsifier, and 72% water. When a portion of the composition was added to water (FIG. 2b), the composition remained as a bead, indicating a water-internal phase. When a portion of the composition was added to Paragon 100 E+ (FIG. 2a), the composition dispersed, again indicating a water-internal phase.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The present invention provides for the following exemplary embodiments, the numbering of which is not to be construed as designating levels of importance:

Embodiment 1 provides a method of treating a subterranean formation, the method comprising: obtaining or providing a composition comprising an oil-external water-internal emulsion comprising an asphaltene-dissolving composition; emulsifier; and aqueous acid; and placing the composition in a subterranean formation downhole.

Embodiment 2 provides the method of Embodiment 1, wherein the obtaining or providing of the composition occurs above-surface.

Embodiment 3 provides the method of any one of Embodiments 1-2, wherein the obtaining or providing of the composition occurs downhole.

Embodiment 4 provides the method of any one of Embodiments 1-3, wherein the method comprises a method of at least one of acidization of the subterranean formation and acid fracturing the subterranean formation; and a method of at least one of asphaltene dissolution and asphaltene deposit prevention.

Embodiment 5 provides the method of any one of Embodiments 1-4, wherein the internal phase is about 50% to about 90% of the oil-external emulsion by volume.

Embodiment 6 provides the method of any one of Embodiments 1-5, wherein the internal phase is about 60% to about 80% of the oil-external emulsion by volume.

Embodiment 7 provides the method of any one of Embodiments 1-6, wherein the external phase is about 10% to about 50% of the oil-external emulsion by volume.

Embodiment 8 provides the method of any one of Embodiments 1-7, wherein the external phase is about 20% to about 40% of the oil-external emulsion by volume.

Embodiment 9 provides the method of any one of Embodiments 1-8, comprising acidizing the subterranean formation with a higher rate of acidization of material in a direction than uniform acidization of surrounding material.

Embodiment 10 provides the method of any one of Embodiments 1-9, comprising acidizing the subterranean formation to generate wormholes.

Embodiment 11 provides the method of any one of Embodiments 1-10, further comprising an asphaltene-removing pre-acidization wash.

Embodiment 12 provides the method of any one of Embodiments 1-11, wherein the method is free of a pre-acidization asphaltene-dissolving pre-wash.

Embodiment 13 provides the method of any one of Embodiments 1-12, further comprising a post-acidization backflush.

Embodiment 14 provides the method of any one of Embodiments 1-13, wherein the composition is substantially free of diesel.

Embodiment 15 provides the method of any one of Embodiments 1-14, wherein the composition is substantially free of organophilic clay.

Embodiment 16 provides the method of any one of Embodiments 1-15, wherein the composition is substantially free of lignite.

Embodiment 17 provides the method of any one of Embodiments 1-16, wherein the composition is placed in the subterranean formation at a pressure less than a fracture pressure of the subterranean formation.

Embodiment 18 provides the method of any one of Embodiments 1-17, wherein the composition is placed in the subterranean formation at a pressure greater than a fracture pressure of the subterranean formation.

Embodiment 19 provides the method of any one of Embodiments 1-18, wherein the composition further comprises proppant.

Embodiment 20 provides the method of any one of Embodiments 19, wherein the method comprises a method of depositing proppant in the subterranean formation.

Embodiment 21. The method of any one of Embodiments 19-20, comprising depositing proppant in at least one of fractures and flowpaths in the subterranean formation.

Embodiment 22 provides the method of any one of Embodiments 1-21, wherein the composition further comprises gravel.

Embodiment 23 provides the method of Embodiment 22, wherein the method comprises a method of gravel packing.

Embodiment 24 provides the method of any one of Embodiments 1-23, wherein the oil-external phase emulsion comprises a viscosity at standard temperature and pressure of about 0.01 cP to about 100,000 cP.

Embodiment 25 provides the method of any one of Embodiments 1-24, wherein the oil-external phase emulsion comprises a viscosity at standard temperature and pressure of 10 cP to about 15,000 cP.

Embodiment 26 provides the method of any one of Embodiments 1-25, wherein at a shear rate of about 0 s⁻¹ to about 1 s⁻¹, the oil-external phase emulsion comprises a viscosity at standard temperature and pressure of 10 cP to about 100,000 cP.

Embodiment 27 provides the method of any one of Embodiments 1-26, wherein at a shear rate of about 0 s⁻¹ to about 1 s⁻¹, the oil-external phase emulsion comprises a viscosity at standard temperature and pressure of 1000 cP to about 100,000 cP.

Embodiment 28 provides the method of any one of Embodiments 1-27, wherein at a shear rate of about 500 s⁻¹ to about 1000 s⁻¹, the oil-external phase emulsion comprises a viscosity at standard temperature and pressure of 10 cP to about 100,000 cP.

Embodiment 29 provides the method of any one of Embodiments 1-28, wherein at a shear rate of about 500 s⁻¹ to about 1000 s⁻¹, the oil-external phase emulsion comprises a viscosity at standard temperature and pressure of 1000 cP to about 100,000 cP.

Embodiment 30 provides the method of any one of Embodiments 1-29, wherein the external phase comprises an oil-soluble polymer.

Embodiment 31 provides the method of any one of Embodiments 1-30, wherein the external phase comprises a corrosion inhibitor.

Embodiment 32 provides the method of Embodiment 31, wherein the corrosion inhibitor is selected from the group consisting of acetylenic alcohols, Mannich condensation products, unsaturated carbonyl compounds, unsaturated ether compounds, formamide, formic acid, formates, other sources of carbonyl, iodides, terpenes, and aromatic hydrocarbons, coffee, tobacco, gelatin, cinnamaldehyde, cinnamaldehyde derivatives, acetylenic alcohols, fluorinated surfactants, quaternary derivatives of heterocyclic nitrogen bases, quaternary derivatives of halomethylated aromatic compounds, combinations of such compounds used in conjunction with iodine; quaternary ammonium compounds; and combinations thereof

Embodiment 33 provides the method of any one of Embodiments 1-32, wherein the external phase comprises the asphaltene-dissolving composition.

Embodiment 34 provides the method of any one of Embodiments 1-33, wherein about 1 wt % to about 100 wt % the external phase is the asphaltene-dissolving composition.

Embodiment 35 provides the method of any one of Embodiments 1-34, wherein the external phase comprises at least one of diesel, a mineral oil, a synthetic oil, a paraffin oil, an olefinic hydrocarbons, an aromatic hydrocarbon, and a glyceride triester.

Embodiment 36 provides the method of any one of Embodiments 1-35, wherein the composition is substantially free of benzene, toluene, ethylbenzene, and xylenes.

Embodiment 37 provides the method of any one of Embodiments 1-36, wherein the asphaltene-dissolving composition comprises an aromatic hydrocarbon composition.

Embodiment 38 provides the method of Embodiment 37, wherein the aromatic hydrocarbon composition is substantially free of benzene, toluene, ethylbenzene, and xylenes.

Embodiment 39 provides the method of any one of Embodiments 37-38, wherein about 1 wt % to about 80 wt % of the emulsion is the aromatic hydrocarbon composition.

Embodiment 40 provides the method of any one of Embodiments 37-39, wherein about 10 wt % to about 30 wt % of the emulsion is the aromatic hydrocarbon composition.

Embodiment 41 provides the method of any one of Embodiments 37-40, wherein about 10 wt % to about 100 wt % of the asphaltene-dissolving composition is the aromatic hydrocarbon composition.

Embodiment 42 provides the method of any one of Embodiments 37-41, wherein about 50 wt % to about 100 wt % of the asphaltene-dissolving composition is the aromatic hydrocarbon composition.

Embodiment 43 provides the method of any one of Embodiments 37-42, wherein the aromatic hydrocarbon composition comprises aromatic petroleum naphtha.

Embodiment 44 provides the method of any one of Embodiments 37-43, wherein the aromatic hydrocarbon composition comprises a mono or poly(C₀-C₁₀)alkyl-substituted (C₅-C₃₀)aromatic hydrocarbon ring system, wherein each alkyl is independently substituted or unsubstituted, wherein each aromatic ring is independently substituted or unsubstituted.

Embodiment 45 provides the method of any one of Embodiments 37-44, wherein the aromatic hydrocarbon composition comprises at least one of mono(C₁-C₁₀)alkyl-substituted benzene, poly(C₁-C₁₀)alkyl-substituted benzene, mono(C₁-C₁₀)alkyl-substituted naphthalene, and poly(C₁-C₁₀)alkyl-substituted naphthalene.

Embodiment 46 provides the method of any one of Embodiments 37-45, wherein about 5 wt % to about 100 wt % of the aromatic hydrocarbon composition is heavy aromatic petroleum naphtha.

Embodiment 47 provides the method of any one of Embodiments 37-46, wherein about 60 wt % to about to about 100 wt % of the aromatic hydrocarbon composition is heavy aromatic petroleum naphtha.

Embodiment 48 provides the method of any one of Embodiments 37-47, wherein the aromatic hydrocarbon composition comprises a C₁₀-C₂₂ compound that is fused aromatic hydrocarbon rings.

Embodiment 49 provides the method of any one of Embodiments 37-48, wherein the aromatic hydrocarbon composition comprises at least one of naphthalene, anthracene, phenanthrene, chrysene, and pyrene.

Embodiment 50 provides the method of any one of Embodiments 37-49, wherein about 0.1 wt % to about 40 wt % of the aromatic hydrocarbon composition is naphthalene.

Embodiment 51 provides the method of any one of Embodiments 37-50, wherein about 2 wt % to about 20 wt % of the aromatic hydrocarbon composition is naphthalene.

Embodiment 52 provides the method of any one of Embodiments 37-51, wherein the aromatic hydrocarbon composition comprises at least one of a di(C₁-C₅)alkylbenzene and a tri(C₁-C₅)alkylbenzene.

Embodiment 53 provides the method of any one of Embodiments 37-52, wherein the aromatic hydrocarbon composition comprises at least one of trimethylbenzene, triethylbenzene, dimethylbenzene, diethylbenzene, methylethylbenzene, dimethylethylbenzene, and diethylmethylbenzene, having substitution patterns of at least one of 1,2-, 1,3-, 1,4-, 1,2,3-, 1,2,4-, 1,2,5-, 1,3,5-, and 1,3,6-.

Embodiment 54 provides the method of any one of Embodiments 37-53, wherein about 0.1 wt % to about 20 wt % of the aromatic hydrocarbon composition is 1,2,4-trimethylbenzene.

Embodiment 55 provides the method of any one of Embodiments 37-54, wherein about 0.5 wt % to about 10 wt % of the aromatic hydrocarbon composition is 1,2,4-trimethylbenzene.

Embodiment 56 provides the method of any one of Embodiments 37-55, wherein the aromatic hydrocarbon composition comprises a di(C₁-C₅)alkylbenzene.

Embodiment 57 provides the method of any one of Embodiments 37-56, wherein the aromatic hydrocarbon composition comprises at least one of 1,2-dimethylbenzene, 1,3-dimethylbenzene, and 1,4-dimethylbenzene.

Embodiment 58 provides the method of any one of Embodiments 37-57, wherein about 10 wt % to about 100 wt % of the aromatic hydrocarbon composition is xylenes.

Embodiment 59 provides the method of any one of Embodiments 37-58, wherein about 30 wt % to about 100 wt % of the aromatic hydrocarbon composition is xylenes.

Embodiment 60 provides the method of any one of Embodiments 37-59, wherein the aromatic hydrocarbon composition comprises a (C₁-C₅)alkylbenzene.

Embodiment 61 provides the method of any one of Embodiments 37-60, wherein the aromatic hydrocarbon composition comprises ethylbenzene.

Embodiment 62 provides the method of any one of Embodiments 37-61, wherein about 1 wt % to about 80 wt % of the aromatic hydrocarbon composition is ethylbenzene.

Embodiment 63 provides the method of any one of Embodiments 37-62, wherein about 5 wt % to about 60 wt % of the aromatic hydrocarbon composition is ethylbenzene.

Embodiment 64 provides the method of any one of Embodiments 37-63, wherein the asphaltene-dissolving composition comprises a polar organic solvent miscible with the aromatic hydrocarbon composition.

Embodiment 65 provides the method of any one of Embodiments 1-64, wherein the asphaltene-dissolving composition comprises a polar organic solvent.

Embodiment 66 provides the method of Embodiment 65, wherein about 0.01 wt % to about 90 wt % of the emulsion is the polar organic solvent.

Embodiment 67 provides the method of any one of Embodiments 65-66, wherein about 0.1 wt % to about 5 wt % of the emulsion is the polar organic solvent.

Embodiment 68 provides the method of any one of Embodiments 65-67, wherein about 0.001 wt % to about 90 wt % of the asphaltene-dissolving composition is the polar organic solvent.

Embodiment 69 provides the method of any one of Embodiments 65-68, wherein about 0.1 wt % to about 20 wt % of the asphaltene-dissolving composition is the polar organic solvent.

Embodiment 70 provides the method of any one of Embodiments 65-69, wherein the polar organic solvent is acetone, chloroform, cichloromethane, tetrahydrofuran, ethyl acetate, acetone, dimethylformamide, acetonitrile, dimethyl sulfoxide, propylene carbonate, formic acid, n-butanol, isopropanol, n-propanol, ethanol, methanol, acetic acid, nitromethane, or N-methylpyrrolidone.

Embodiment 71 provides the method of any one of Embodiments 65-70, wherein about 30 wt % to about 100 wt % of the polar organic solvent is N-methylpyrrolidone.

Embodiment 72 provides the method of any one of Embodiments 1-71, wherein the internal phase of the oil-external emulsion comprises the aqueous acid.

Embodiment 73 provides the method of any one of Embodiments 1-72, wherein about 10 wt % to about 99 wt % of the emulsion is the aqueous acid.

Embodiment 74 provides the method of any one of Embodiments 1-73, wherein about 40 wt % to about 90 wt % of the emulsion is the aqueous acid.

Embodiment 75 provides the method of any one of Embodiments 1-74, wherein the aqueous acid is 0.1 wt % acid to about 99 wt % acid.

Embodiment 76 provides the method of any one of Embodiments 1-75, wherein the aqueous acid is about 5 wt % to about 50 wt % acid.

Embodiment 77 provides the method of any one of Embodiments 1-76, wherein the acid is at least one of hydrochloric acid, sulfuric acid, fluoric acid, nitric acid, phosphoric acid, boric acid, hydrobromic acid, perchloric acid, acetic acid, formic acid, lactic acid, citric acid, oxalic acid, uric acid, glutaric acid, glutamic acid, adipic acid, and phthalic acid.

Embodiment 78 provides the method of any one of Embodiments 1-77, wherein the internal phase has an initial pH of −20 to about 6.

Embodiment 79 provides the method of any one of Embodiments 1-78, wherein the internal phase has an initial pH of −2 to about 3.

Embodiment 80 provides the method of any one of Embodiments 1-79, wherein the internal phase comprises at least one salt.

Embodiment 81 provides the method of Embodiment 80, wherein the salt is at least one of calcium chloride, sodium chloride, potassium chloride, magnesium chloride, calcium bromide, sodium bromide, potassium bromide, calcium nitrate, sodium formate, potassium formate, and cesium formate.

Embodiment 82 provides the method of any one of Embodiments 1-81, wherein the emulsifier is about 0.01-10 wt % of the oil-external emulsion.

Embodiment 83 provides the method of any one of Embodiments 1-82, wherein the emulsifier is about 0.1 wt % to about 5 wt % of the oil-external emulsion.

Embodiment 84 provides the method of any one of Embodiments 1-83, wherein the emulsifier comprises at least one of a sulfate, sulfonate, phosphate, carboxylate, tri(C₁-C₁₀)alkylammonium halide, substituted or unsubstituted fatty alcohol, substituted or unsubstituted fatty acid, substituted or unsubstituted fatty acid ester, and a substituted or unsubstituted poly((C₁-C₁₀)hydrocarbylene oxide) independently having H or (C₁-C₁₀)hydrocarbylene as end-groups.

Embodiment 85 provides the method of any one of Embodiments 1-84, wherein the emulsifier comprises ammonium aluryl sulfate, sodium lauryl sulfate, sodium laureth sulfate, sodium myreth sulfate, dioctyl sodium sulfosuccinate, perfluorooctanesulfonate, perfluorobutanesulfonate, linear (C₁-C₁₀) alkylbenzene sulfonate, sodium stearate, sodium lauroyl sarcosinate, perfluorononanoate, perfluorooctanoate, octenidine dihydrochloride, certyl trimethylammonium bromide, cetyl trimethylammonium chloride, cetylpyridinium chloride, benzalkonium chloride, benzethonium chloride, 5-bromo-5-nitro-1,3-dioxane, dimethyldiactadecylammonium chloride, cetrimonium bromide, dioctadecyldimethylammonium bromide, 3-[(3-cholamidopropyl) dimethylammonio]-1-propanesulfonate, cocamidopropyl hydroxysultaine, cocamidopropyl betaine, lecithin, a polyoxyethylene glycol alkyl ether , a polyoxypropylene glycol ether, a glucoside alkyl ether, a polyoxyethylene glycol octylphenol ether, a polyoxyethylene glycol alkylphenol ether, a glycerol alkyl ether, a polyoxyethylene glycol sorbitan alkyl ester, cocamide monoethanolamine, cocamide diethanolamine, dodecyldimethylaminde oxide, a poloxamer, and a polyethoxylated tallow amine.

Embodiment 86 provides the method of any one of Embodiments 1-85, wherein the emulsifier comprises ethylene glycol monobutyl ether.

Embodiment 87 provides the method of any one of Embodiments 1-86, wherein the emulsifier is about 0.01 wt % to about 20 wt % ethylene glycol monobutyl ether.

Embodiment 88 provides the method of any one of Embodiments 1-87, wherein the emulsifier comprises diethylene glycol monobutyl ether.

Embodiment 89 provides the method of any one of Embodiments 1-88, wherein the emulsifier is about 0.01 wt % to about 20 wt % diethylene glycol monobutyl ether.

Embodiment 90 provides the method of any one of Embodiments 1-89, wherein the emulsifier comprises a petroleum distillate.

Embodiment 91 provides the method of any one of Embodiments 1-90, wherein the emulsifier comprises a hydrotreated light petroleum distillate.

Embodiment 92 provides the method of any one of Embodiments 1-91, wherein the emulsifier is about 1 wt % to about 90 wt % hydrotreated light petroleum distillate.

Embodiment 93 provides the method of any one of Embodiments 1-92, wherein the emulsifier comprises at least one of a polyaminated (C₃-C₅₀)fatty acid and a polyaminated (C₃-C₅₀)fatty acid (C₁-C₁₀)alkyl ester.

Embodiment 94 provides the method of any one of Embodiments 1-93, wherein the emulsifier is about 1 wt % to about 100 wt % of a polyaminated fatty acid.

Embodiment 95 provides the method of any one of Embodiments 1-94, wherein the emulsifier comprises at least one of a polyaminated fatty acid and a polyaminated fatty acid alkyl ester.

Embodiment 96 provides the method of any one of Embodiments 1-95, wherein the emulsifier has a Davies' scale hydrophilic-liphophilic balance (HLB) of about 3 to about 7.

Embodiment 97 provides the method of any one of Embodiments 1-96, wherein the emulsifier has a Griffin's index hydrophilic-liphophilic balance (HLB) of about 7 to about 11.

Embodiment 98 provides the method of any one of Embodiments 1-97, wherein the oil-external emulsion comprises a viscosifier.

Embodiment 99 provides the method of any one of Embodiments 1-98, wherein the oil-external emulsion comprises a crosslinked gel or a crosslinkable gel.

Embodiment 100 provides the method of Embodiment 99, wherein the crosslinked gel or crosslinkable gel comprises at least one of a linear polysaccharide and a poly((C₂-C₁₀)alkenylene), wherein the (C₂-C₁₀)alkenylene is substituted or unsubstituted. The gel or crosslinked gel can include least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), acetan, alginate, chitosan, curdlan, a cyclosophoran, dextran, emulsan, a galactoglucopolysaccharide, gellan, glucuronan, N-acetyl-glucosamine, N-acetyl-heparosan, hyaluronic acid, indicant, kefiran, lentinan, levan, mauran, pullulan, scleroglucan, schizophyllan, stewartan, succinoglycan, xanthan, welan, starch, tamarind, tragacanth, guar gum, derivatized guar, gum ghatti, gum arabic, locust bean gum, cellulose, and derivatized cellulose. The gel or crosslinked gel can include cellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar.

Embodiment 101 provides the method of any one of Embodiments 1-100, wherein the oil-external emulsion comprises a crosslinker.

Embodiment 102 provides the method of Embodiment 101, wherein the crosslinker comprises at least one of chromium, aluminum, antimony, zirconium, titanium, calcium, boron, iron, silicon, copper, zinc, magnesium, and an ion thereof

Embodiment 103 provides the method of any one of Embodiments 101-102, wherein the crosslinker comprises at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, and zirconium lactate glycolate, titanium lactate, titanium malate, titanium citrate, titanium ammonium lactate, titanium triethanolamine, titanium acetylacetonate, aluminum lactate, or aluminum citrate.

Embodiment 104 provides the method of any one of Embodiments 1-103, wherein the composition or emulsion further comprises water, saline, aqueous base, oil, organic solvent, synthetic fluid oil phase, aqueous solution, alcohol or polyol, cellulose, starch, alkalinity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, gas, weight reducing additive, heavy-weight additive, lost circulation material, filtration control additive, dispersant, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, fly ash, metakaolin, shale, zeolite, a crystalline silica compound, amorphous silica, fibers, a hydratable clay, microspheres, pozzolan lime, or a combination thereof.

Embodiment 105 provides the method of any one of Embodiments 1-104, further comprising combining the composition with an aqueous or oil-based fluid comprising a drilling fluid, stimulation fluid, fracturing fluid, spotting fluid, clean-up fluid, production fluid, completion fluid, remedial treatment fluid, abandonment fluid, pill, acidizing fluid, packer fluid, or a combination thereof, to form a mixture, wherein the placing the composition in the subterranean formation comprises placing the mixture in the subterranean formation.

Embodiment 106 provides the method of any one of Embodiments 1-105, wherein at least one of prior to, during, and after the placing of the composition in the subterranean formation, the composition is used downhole, at least one of alone and in combination with other materials, as a drilling fluid, stimulation fluid, fracturing fluid, spotting fluid, clean-up fluid, production fluid, completion fluid, remedial treatment fluid, abandonment fluid, pill, acidizing fluid, packer fluid, or a combination thereof

Embodiment 107 provides the method of any one of Embodiments 1-106, wherein the placement of the composition in the subterranean formation comprises fracturing at least part of the subterranean formation to form at least one subterranean fracture.

Embodiment 108 provides the method of any one of Embodiments 1-107, wherein the composition further comprises a proppant, a resin-coated proppant, an encapsulated resin, or a combination thereof

Embodiment 109 provides the method of any one of Embodiments 1-110, wherein the composition comprises a payload material.

Embodiment 110 provides the method of Embodiment 109, further comprising using the composition to deposit at least part of the payload material downhole.

Embodiment 111 provides the method of any one of Embodiments 109-110, wherein the at least part of the payload material is deposited in a subterranean fracture.

Embodiment 112 provides the method of any one of Embodiments 109-111, wherein the payload material comprises a proppant, a resin-coated proppant, a curable material, an encapsulated resin, a resin, fly ash, metakaolin, shale, zeolite, a set retarding additive, a surfactant, a gas, an accelerator, a weight reducing additive, a heavy-weight additive, a lost circulation material, a filtration control additive, a dispersant, a crystalline silica compound, an amorphous silica, a salt, a fiber, a hydratable clay, a microsphere, pozzolan lime, a thixotropic additive, water, an aqueous base, an aqueous acid, an alcohol or polyol, a cellulose, a starch, an alkalinity control agent, a density control agent, a density modifier, a surfactant, an emulsifier, a dispersant, a polymeric stabilizer, a crosslinking agent, a polyacrylamide, a polymer or combination of polymers, an antioxidant, a heat stabilizer, a foam control agent, a solvent, a diluent, a plasticizer, a filler or inorganic particle, a pigment, a dye, a precipitating agent, a rheology modifier, or a combination thereof

Embodiment 113 provides a method of treating a subterranean formation, the method comprising: obtaining or providing a composition comprising an oil-external water-internal emulsion comprising an external phase comprising an asphaltene-dissolving composition comprising heavy aromatic petroleum naptha and a polar organic compound miscible with the heavy aromatic petroleum naptha, wherein the external phase is about 10% to about 50% of the oil-external emulsion by volume; an internal phase comprising aqueous acid, wherein the internal phase is about about 50% to about 90% of the oil-external emulsion by volume; and emulsifier comprising a polyaminated fatty acid; and placing the composition in a subterranean formation.

Embodiment 114 provides a system comprising: a composition comprising an oil-external water-internal emulsion comprising an asphaltene-dissolving composition; emulsifier; and aqueous acid; and a subterranean formation comprising the composition therein.

Embodiment 115 provides a composition for treatment of a subterranean formation, the composition comprising: an oil-external water-internal emulsion comprising an asphaltene-dissolving composition; emulsifier; and aqueous acid.

Embodiment 116 provides the composition of Embodiment 115, wherein the composition further comprises a downhole fluid.

Embodiment 117 provides the composition of any one of Embodiments 115-116, wherein the composition is a composition for fracturing of a subterranean formation.

Embodiment 118 provides a composition for treatment of a subterranean formation, the composition comprising: an oil-external water-internal emulsion comprising an external phase comprising an asphaltene-dissolving composition comprising heavy aromatic petroleum naptha and a polar organic compound miscible with the heavy aromatic petroleum naptha, wherein the external phase is about 10% to about 50% of the oil-external emulsion by volume; an internal phase comprising aqueous acid, wherein the internal phase is about about 50% to about 90% of the oil-external emulsion by volume; and emulsifier comprising a polyaminated fatty acid.

Embodiment 119 provides a method of preparing a composition for treatment of a subterranean formation, the method comprising: forming an oil-external water-internal emulsion comprising an asphaltene-dissolving composition; emulsifier; and aqueous acid.

Embodiment 120 provides the apparatus or method of any one or any combination of Embodiments 1-119 optionally configured such that all elements or options recited are available to use or select from.

1-119. (canceled)

120. A method of treating a subterranean formation, the method comprising:
placing in the subterranean formation a composition comprising an oil-external water-internal emulsion comprising
an asphaltene-dissolving composition;
emulsifier; and
aqueous acid.

121. The method of claim 120, wherein the composition is substantially free of diesel.

122. The method of claim 120, wherein the composition is substantially free of organophilic clay.

123. The method of claim 120, wherein the composition is substantially free of lignite.

124. The method of claim 120, wherein the composition is substantially free of benzene, toluene, ethylbenzene, and xylenes.

125. The method of claim 120, wherein the external phase comprises the asphaltene-dissolving composition.

126. The method of claim 120, wherein the asphaltene-dissolving composition comprises an aromatic hydrocarbon composition.

127. The method of claim 126, wherein the aromatic hydrocarbon composition comprises aromatic petroleum naphtha.

128. The method of claim 126, wherein the aromatic hydrocarbon composition comprises a mono or poly(C₀-C₁₀)alkyl-substituted (C₅-C₃₀)aromatic hydrocarbon ring system, wherein each alkyl is independently substituted or unsubstituted, wherein each aromatic ring is independently substituted or unsubstituted.

129. The method of claim 126, wherein the aromatic hydrocarbon composition comprises a C₁₀-C₂₂ compound that is a fused aromatic hydrocarbon ring system.

130. The method of claim 126, wherein the aromatic hydrocarbon composition comprises at least one of a di(C₁-C₅)alkylbenzene and a tri(C₁-C₅)alkylbenzene.

131. The method of claim 126, wherein the aromatic hydrocarbon composition comprises a di(C₁-C₅)alkylbenzene.

132. The method of claim 126, wherein the aromatic hydrocarbon composition comprises a (C₁-C₅)alkylbenzene.

133. The method of claim 126, wherein the asphaltene-dissolving composition comprises a polar organic solvent miscible with the aromatic hydrocarbon composition.

134. The method of claim 120, wherein the asphaltene-dissolving composition comprises a polar organic solvent.

135. The method of claim 120, wherein the internal phase of the oil-external emulsion comprises the aqueous acid, wherein the acid is at least one of hydrochloric acid, sulfuric acid, fluoric acid, nitric acid, phosphoric acid, boric acid, hydrobromic acid, perchloric acid, acetic acid, formic acid, lactic acid, citric acid, oxalic acid, uric acid, glutaric acid, glutamic acid, adipic acid, and phthalic acid.

136. The method of claim 120, wherein the emulsifier comprises at least one of a sulfate, sulfonate, phosphate, carboxylate, tri(C₁-C₁₀)alkylammonium halide, substituted or unsubstituted fatty alcohol, substituted or unsubstituted fatty acid, substituted or unsubstituted fatty acid ester, and a substituted or unsubstituted poly((C₁-C₁₀)hydrocarbylene oxide) independently having H or (C₁-C₁₀)hydrocarbylene as end-groups.

137. The method of claim 120, wherein the emulsifier comprises ammonium aluryl sulfate, sodium lauryl sulfate, sodium laureth sulfate, sodium myreth sulfate, dioctyl sodium sulfosuccinate, perfluorooctanesulfonate, perfluorobutanesulfonate, linear (C₁-C₁₀)alkylbenzene sulfonate, sodium stearate, sodium lauroyl sarcosinate, perfluorononanoate, perfluorooctanoate, octenidine dihydrochloride, certyl trimethylammonium bromide, cetyl trimethylammonium chloride, cetylpyridinium chloride, benzalkonium chloride, benzethonium chloride, 5-bromo-5-nitro-1,3-dioxane, dimethyldiactadecylammonium chloride, cetrimonium bromide, dioctadecyldimethylammonium bromide, 3-[(3-cholamidopropyl)dimethylammonio]-1-propanesulfonate, cocamidopropyl hydroxysultaine, cocamidopropyl betaine, lecithin, a polyoxyethylene glycol alkyl ether, a polyoxypropylene glycol ether, a glucoside alkyl ether, a polyoxyethylene glycol octylphenol ether, a polyoxyethylene glycol alkylphenol ether, a glycerol alkyl ether, a polyoxyethylene glycol sorbitan alkyl ester, cocamide monoethanolamine, cocamide diethanolamine, dodecyldimethylaminde oxide, a poloxamer, and a polyethoxylated tallow amine.

138. A method of treating a subterranean formation, the method comprising:
placing in the subterranean formation a composition comprising an oil-external water-internal emulsion comprising
an external phase comprising an asphaltene-dissolving composition comprising heavy aromatic petroleum naphtha and a polar organic compound miscible with the heavy aromatic petroleum naptha, wherein the external phase is about 10% to about 50% of the oil-external emulsion by volume;
an internal phase comprising aqueous acid, wherein the internal phase is about about 50% to about 90% of the oil-external emulsion by volume; and emulsifier comprising a polyaminated fatty acid.

139. A system comprising:
a tubular disposed in a subterranean formation; and
a pump configured to pump a composition comprising an oil-external water-internal emulsion through the tubular in the subterranean formation, the oil-external water-internal emulsion comprising
an asphaltene-dissolving composition;
emulsifier; and
aqueous acid.
